(19) United States
(12) Patent Application Publication
(10) Pub. No.: US 2008/0021943 A1
(43) Pub. Date: Jan. 24, 2008

(54) Equality comparator using propagates and generates

(75) Inventor: Kok-Hoong Chiu, Austin, TX (US)

Correspondence Address: LARSON NEWMAN ABEL POLANSKY & WHITE, LLP, 5914 WEST COURTYARD DRIVE, SUITE 200, AUSTIN, TX, 78730, US

(73) Assignee: Advanced Micro Devices, Inc., Sunnyvale, CA (US)

(21) Appl. No.: 11/490,338

(22) Filed: Jul. 20, 2006

(51) Int. Cl. G06F 7/00

(52) U.S. Cl. 708/212

(57) ABSTRACT

A carry lookahead adder is employed to determine an equality relationship and one or more inequality relationships between two operands. The carry lookahead adder includes a hierarchy of carry lookahead stages, each carry lookahead stage using either corresponding bits of the two operands or the carry generate values and carry propagate values from the prior stage to generate carry generate values and carry propagate values for use at the next stage. Equality logic receives a subset of the carry generate values and carry propagate values and, based on this subset of values, provides an equality relationship indicator that indicates the equality relationship between the two operands, or portions thereof. Further, inequality logic also receives a subset of the carry generate values and carry propagate values, and based on this subset of values, provides an inequality relationship indicator that indicates an inequality relationship between the two operands, or portions thereof.

### FIELD OF THE DISCLOSURE

The present disclosure relates generally to comparing operands at a processing device and more particularly to determining an equality relationship between operands.

### BACKGROUND

Processing device operations often make use of the value relationship between two operands. To determine whether two operands are equal, a processing device conventionally employs separate and distinct equality comparator logic implemented as a complex hierarchy of XNOR, NOR or NAND gate structures that receives two operands and provides an output indicating whether the two operands are equal. Further, conventional processing devices implement a separate logic structure, typically a carry lookahead adder, that receives the two operands and provides an output indicating which one of the two operands is greater than the other. This use of two entirely separate logic structures to determine the value relationship between the two operands typically results in unnecessary power consumption and additional layout area. Accordingly, an improved technique for determining the equality relationship and inequality relationships between operands would be advantageous.

### BRIEF DESCRIPTION OF THE DRAWINGS

The purpose and advantages of the present disclosure will be apparent to those of ordinary skill in the art from the following detailed description in conjunction with the appended drawings in which like reference characters are used to indicate like elements, and in which:

FIG. 1 is a block diagram illustrating an exemplary processing device employing an adder/comparator in accordance with one embodiment of the present disclosure.

FIG. 2 is a block diagram illustrating an exemplary implementation of the adder/comparator of FIG. 1 in accordance with one embodiment of the present disclosure.

FIG. 3 is a block diagram illustrating an alternate exemplary implementation of the adder/comparator of FIG. 1 in accordance with one embodiment of the present disclosure.

FIG. 4 is a block diagram illustrating an exemplary carry lookahead adder in accordance with one embodiment of the present disclosure.

FIG. 5 is a circuit diagram illustrating an exemplary inequality comparator circuit using the carry lookahead adder of FIG. 4 in accordance with one embodiment of the present disclosure.

FIG. 6 is a circuit diagram illustrating an exemplary equality comparator circuit using the carry lookahead adder of FIG. 4 in accordance with one embodiment of the present disclosure.

### DETAILED DESCRIPTION OF THE DISCLOSURE

The following description is intended to convey a thorough understanding of the present disclosure by providing a number of specific embodiments and details involving the comparison of two operands. It is understood, however, that the present disclosure is not limited to these specific embodiments and details, which are exemplary only. It is further understood that one possessing ordinary skill in the art, in light of known systems and methods, would appreciate the use of the disclosure for its intended purposes and benefits in any number of alternative embodiments, depending upon specific design and other needs.

In accordance with at least one aspect of the present disclosure, a method includes determining a first carry propagate value and a second carry generate value based on a first carry lookahead operation for a first operand and a second operand. The method further includes determining a second carry propagate value and a second carry generate value based on a second carry lookahead operation for the first operand and the second operand and determining an equality relationship between the first operand and the second operand based on at least two of the first carry propagate value, the second carry propagate value, the first carry generate value and the second carry generate value. The method additionally includes determining a first inequality relationship between the first operand and the second operand based on at least two of the first carry propagate value, the second carry propagate value, the first carry generate value and the second carry generate value.

In accordance with another aspect of the present disclosure, a device includes a carry lookahead adder having a first input to receive a first operand, a second input to receive a second operand, a plurality of carry lookahead stages, a first plurality of outputs and a second plurality of outputs. Each of the first plurality of outputs is to provide a corresponding carry propagate value of a corresponding carry lookahead stage of the plurality of hierarchical carry lookahead stages and each of the second plurality of outputs is to provide a corresponding carry generate value of a corresponding carry lookahead stage of the plurality of carry lookahead stages. The device further includes logic having a first plurality of inputs, each coupled to a corresponding one of the first plurality of outputs, a second plurality of inputs, each coupled to a corresponding one of the second plurality of outputs, and an output to provide an equality relationship indicator based on at least a first subset of the carry propagate values and at least a first subset of the carry generate values of the carry lookahead adder.

In accordance with another aspect of the present disclosure, a processing device includes logic to determine a first carry propagate value and a second carry generate value based on a first carry lookahead operation for a first operand and a second operand and logic to determine a second carry propagate value and a second carry generate value based on a second carry lookahead operation for the first operand and the second operand. The processing device further includes logic to determine an equality relationship between the first operand and the second operand based on at least two of the first carry propagate value, the second carry propagate value, the first carry generate value and the second carry generate value and logic to determine a first inequality relationship between the first operand and the second operand based on at least two of the first carry propagate value, the second carry propagate value, the first carry generate value and the second carry generate value.

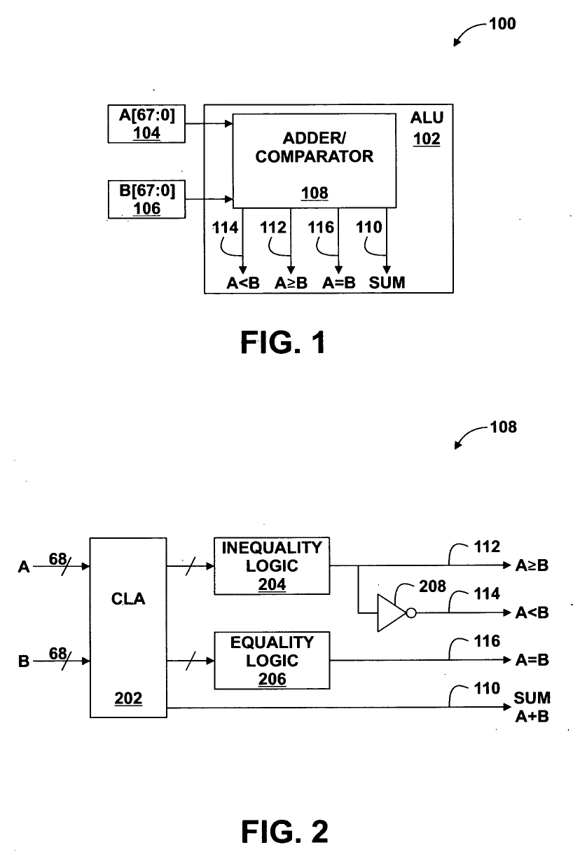

FIGS. 1-6 illustrate exemplary techniques for employing a carry lookahead adder to determine an equality relationship and one or more inequality relationships between two operands at a processing device. In one embodiment, the carry lookahead adder comprises a hierarchy of carry lookahead stages, where each carry lookahead stage uses either corresponding bits of the two operands or the carry generate values and carry propagate values from the prior stage to generate carry generate values and carry propagate values for use at the next stage. Equality logic receives a subset of the carry generate values and carry propagate values and, based on this subset of values, provides an equality relationship indicator that indicates the equality relationship between the two operands (or between portions of the two operands). Further, inequality logic also receives a subset of the carry generate values and carry propagate values, and based on this subset of values, provides an inequality relationship indicator that indicates an inequality relationship between the two operands, or portions thereof. Further, in one embodiment, the carry lookahead adder provides a sum output indicating the sum of the two operands. This use of the values at the stages of the carry lookahead adder to determine both an equality relationship and an inequality relationship between two operands reduces the power consumption and gate layout area compared to conventional techniques that employ separate equality and inequality comparators.

The term “equality relationship” indicates the relationship between two operands with respect to whether they are the same value. Thus, the equality relationships are “equal to” or “not equal to.” The term “inequality relationship” indicates the relationship between two operands with respect to the value of which operand is at least as great as the value of the other operand. Thus, the inequality relationships are “greater than,” “greater than or equal to,” “less than,” or “less than or equal to.”

Referring to FIG. 1 an exemplary processing device 100 is illustrated in accordance with at least one embodiment of the present disclosure. The processing device 100 can include, for example, a microprocessor, a microcontroller, an application specific integrated circuit (ASIC), a system on a chip (SOC), and the like. As illustrated, the processing device 100 includes an arithmetic logic unit (ALU) 102 and a plurality of registers (e.g., registers 104 and 106) to store operands for use by the ALU 102 during the execution of instructions. The ALU 102 includes an adder/comparator 108 having a first input to receive the operand (operand A) stored in the register 104 and a second input to receive the operand (operand B) stored in the register 106. For purposes of illustration, operands A and B are discussed herein in the context of 68-bit operand values (A[67:0) and B[67:0]).

The adder/comparator 108 further includes an output 110 to provide a sum indicator of the sum of operands A and B and an output 112 to provide a first inequality relationship indicator of a first inequality relationship of operand A and operand B, e.g., an indicator that indicates whether operand A is greater than or equal to B (A≧B). The adder/comparator 108 further includes an output 114 to provide a second inequality relationship indicator of a second inequality relationship of operand A and operand B, e.g., an indicator that indicates whether operator A is less than B (A<B). The adder/comparator 108 also includes an output 116 to provide an equality relationship indicator of the equality relationship between operand A and operand B.

The adder/comparator 108, in one embodiment, includes a carry lookahead adder implemented as a sequence of carry lookahead stages. The initial carry lookahead stage receives the bit values of operands A and B and generates a plurality of carry generate values and carry propagate values. The subsequent stages use the carry propagate values and the carry generate values to generate carry propagate values and carry lookahead values for the next stage. The adder/comparator 108 includes logic to utilize some or all of the carry generate values and carry propagate values at one or more of the stages to provide the sum, first inequality relationship indicator, the second inequality relationship indicator, and the equality relationship indicator at the outputs 110, 112, 114 and 116, respectively. As discussed in greater detail herein, the logic processes the operands A and B for the sum indicator, the first inequality relationship indicator, the second inequality relationship indicator and the equality relationship indicator substantially in parallel so that these indicators are available for output substantially simultaneously, e.g., within at most a couple of gate delays of each other.

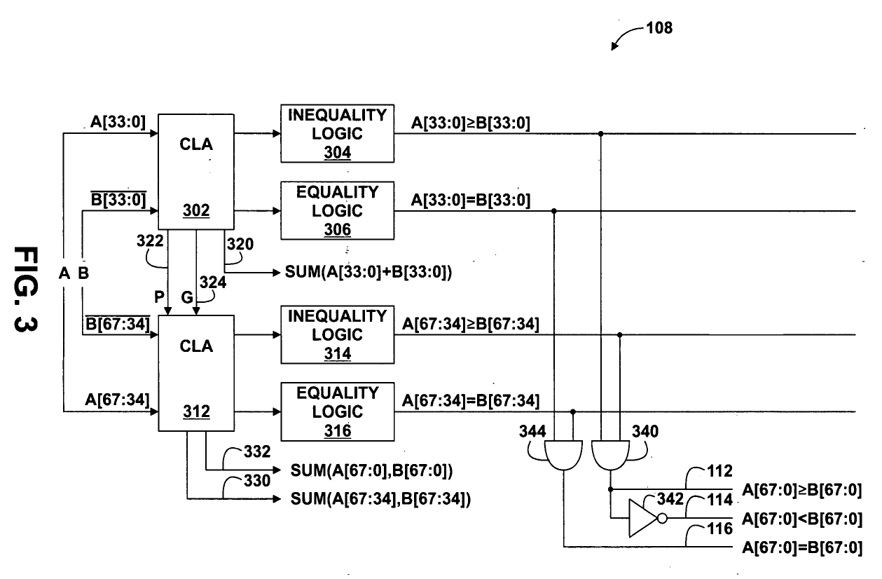

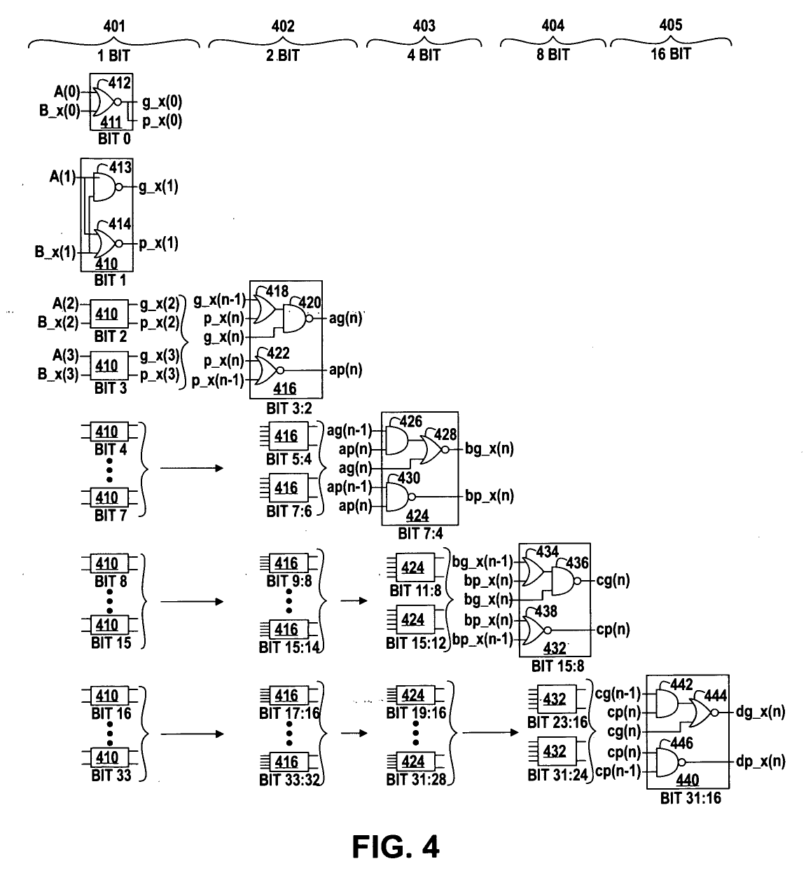

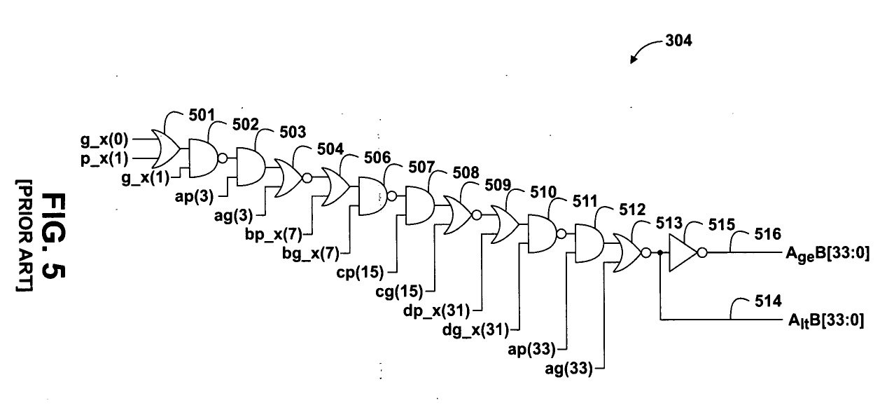

Referring to FIG. 2, an exemplary implementation of the adder/comparator 108 is illustrated in accordance with at least one embodiment of the present disclosure. In the depicted example, the adder/comparator 108 includes a carry lookahead adder (CLA) 202, inequality logic 204 and equality logic 206. The carry lookahead adder 202 includes a first input to receive the operand A and a second input to receive the operand B. In operation, the carry lookahead adder 202 implements a sequence of carry lookahead addition operations to determine a sum of the operands A and B, which is provided via the output 110. Each of the carry lookahead addition operations results in the generation of a carry propagate value and a carry generate value. The carry lookahead adder 202 further includes an output to provide a first subset of the carry propagate values and carry generate values and an output to provide a second subset of the carry propagate values and carry generate values. The first subset and the second subset may have the same values or different values. An exemplary implementation of the carry lookahead adder 202 is described in greater detail herein with reference to FIG. 4.

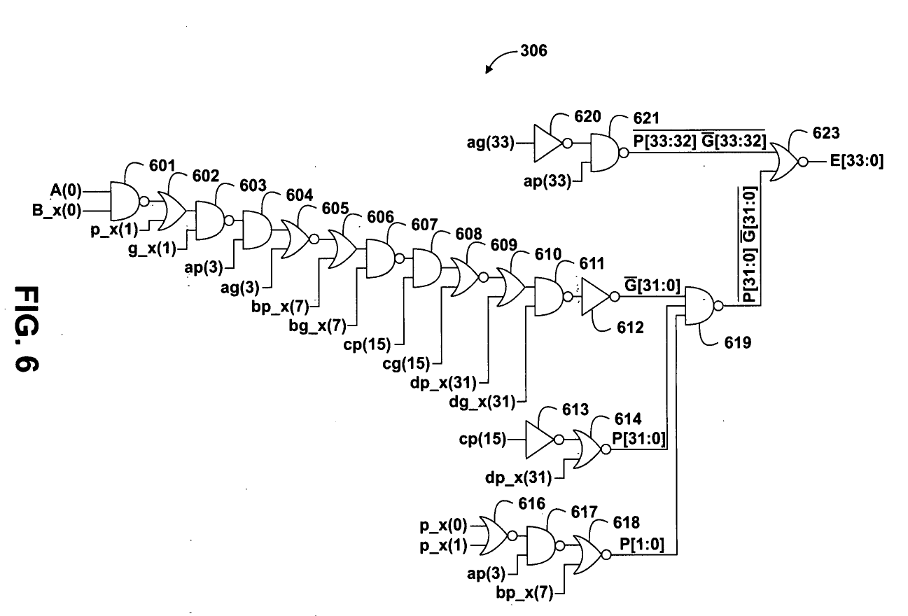

The inequality logic 204 includes an input to receive the first subset of carry generate values and carry propagate values and output coupled to the output 112 to provide the first inequality relationship indicator based on the first subset. In the illustrated example, the inequality logic 204 determines whether operand A is greater than or equal to operand B and thus the first inequality relationship indicator output by the inequality logic 204 indicates whether the value of operand A is at least as great as the value of operand B. In this instance, an inverter 208 having an input coupled to the output of the inequality logic 204 and an output coupled to the output 114 can be used to provide the second inequality relationship indicator (indicating whether the value of operand A is less than the value of operand B)(i.e., (A≧B)→(A<B)). An exemplary implementation of the inequality logic 204 is described in greater detail herein with reference to FIG. 5.

The equality logic 206 includes an input to receive the second subset of carry generate values and carry propagate values and an output coupled to the output 116 to provide the equality relationship indicator based on the second subset. An exemplary implementation of the equality logic 206 is described in greater detail herein with reference to FIG. 6.

Referring to FIG. 3, an alternate implementation of the adder/comparator 108 is illustrated in accordance with one embodiment of the present disclosure. In certain instances, it can be advantageous to determine the sum, inequality relationships and equality relationship for portions of the operands in parallel. In the depicted example, the adder/comparator 108 includes a carry lookahead adder 302 to sum the less significant bits of operands A and B (A[33:0] and B[33:0]). The adder/comparator 108 further includes inequality logic 304 to provide a first inequality relationship indicator for the less significant bits of operands A and B based on a first set of carry generate values and carry propagate values from the carry lookahead adder 302, and equality logic 306 to provide the equality relationship indicator for the less significant bits of operands A and B based on a second set of carry generate values and carry propagate values from the carry lookahead adder 302 (where the first set can be the same as or different from the second set depending on implementation). For the more significant bit portions of the operands A and B (A[67:34] and B[67:34]), the adder/comparator 108 includes a carry lookahead adder 312 to sum the more significant bits of operands A and B. The adder/comparator 108 further includes inequality logic 314 to provide the first inequality relationship indicator for the more significant bits of operands A and B based on a third set of carry generate values and carry propagate values from the carry lookahead adder 312, and equality logic 316 to provide the equality relationship indicator for the more significant bits of operands A and B based on a fourth set of carry generate values and carry propagate values from the carry lookahead adder 312(where the third set can be the same as or different from the fourth set depending on implementation).

The carry lookahead adder 302 includes an output 320 to provide the sum indicator for the sum of operand portions A[33:0] and B[33:0], and outputs 322 and 324 to provide the carry propagate value and carry generate value, respectively, generated at the last stage of the carry lookahead adder 302. The carry lookahead adder 312 includes an output 330 to provide the sum indicator for the sum of operand portions A[67:34] and B[67:34], and an output 332 to provide the sum indicator for the sum of operands A and B (i.e., the sum of A[67:0] and B[67:0]).

In operation, the carry lookahead adder 302 sums the operand portions A[33:0] and B[33:0] and provides the resulting sum, final carry propagate value and final carry generate value as outputs 320, 322 and 324. The carry propagate values and carry generate values generated at the carry lookahead adder 302 are then used by the inequality logic 304 and the equality logic 306 to generate an inequality relationship indicator and the equality relationship indicator, respectively, for the operand portions A[33:0] and B[33:0]. It will be appreciated that the total sum of operands A and B cannot be conclusively determined by the carry lookahead adder 312 until the final carry generate value and the final carry propagate value are provided from the carry lookahead adder 302. Accordingly, while the carry lookahead 302 is performing its sum operation, the carry lookahead adder 312, in one embodiment, sums the operand portions A[67:34] and B[67:34] and provides the resulting sum at output 330. Further, the carry generate values and carry propagate values generated by the carry lookahead adder 312 while summing the more significant bit operand portions are used by the inequality logic 314 and the equality logic 316 to generate an inequality relationship indicator and the equality relationship indicator, respectively, for the operand portions A[67:34] and B[67:34]. Once the final carry propagate value and final carry generate value are available from the carry lookahead adder 302, the carry lookahead adder 312 can repeat the carry lookahead operation using the operand portions A[67:34] and B[67:34], the final carry propagate value and the final carry generate value to determine the total sum of operands A and B for output as a total sum indicator at output 332.

The adder/comparator 108 further includes an AND gate 340 having one input connected to the output of the inequality logic 304, another input connected to the output of the inequality logic 314, and an output connected to the output 112 of the adder/comparator 108. Thus, when the first inequality indicator output by inequality logic 304 and the first inequality indicator output by the inequality logic 314 both are asserted (i.e., each portion of operand A is greater than or equal to the corresponding portion of operand B), the output 112 is asserted, thereby indicating that operand A is greater than or equal to operand B. Otherwise, the output 112 is unasserted, indicating that operand A less than B. Accordingly, an inverter 342 having an input connected to the output of the AND gate 340 and an output connected to the output 114 can be used to provide the second inequality indicator (i.e., whether operand A is less than operand B). The adder/comparator 108 also includes an AND gate 344 having an input connected to the output of the equality logic 306, another input connected to the output of the equality logic 316, and an output connected to the output 116 of the adder/comparator. Thus, when the outputs of both the equality logic 306 and 316 are asserted (i.e., each portion of operand A is equal to the corresponding portion of operand B), the output 116 is asserted, thereby indicating that operands A and B are equal. Otherwise, the output 116 is unasserted, thereby indicating that operands A and B are not equal.

Referring to FIG. 4, an exemplary implementation of a carry lookahead adder 400 is illustrated in accordance with at least one embodiment of the present disclosure. The illustrated implementation can be employed for each of the carry lookahead adders 302 and 312 of FIG. 3, or scaled for use as the carry lookahead adder 202 of FIG. 2.

In the depicted example, the carry lookahead adder 400 performs two's complement addition for corresponding portions of operands A and B based on a sequence of hierarchical carry lookahead addition operations on the portion of operand A and the inverted representation of the operand B to generate a final carry generate value and a final carry propagate value. For ease of reference, the construct “_x” is used to denote a value that has an inverted representation. In the illustrated example, the carry lookahead adder 400 is implemented as six stages (stages 401-406, respectively). Each of the stages 401-406 includes a plurality of carry lookahead operation modules. Each carry lookahead operation module 410 of the first stage 401 includes an input to receive a corresponding bit value of operand A (denoted bit A(N), where N=0 . . . 33) and an input to receive a corresponding inverted bit value of operand B (denoted bit B_X(N), where N=0 . . . 33). Each carry lookahead operation module 410 further includes an output to provide a corresponding carry generate value (denoted as g_x(N), where N=0 . . . 33) and a corresponding carry propagate value (denoted as p_x(N), where N=0 . . . 33). Further, because the carry lookahead adder 400 is performing two's complement addition, the carry lookahead operation module of stage 401 that receives the least significant bits of the operands A and B (denoted as element 411 in FIG. 4 for ease of identification) includes an NOR gate 412 having one input to receive bit A(0), another input to receive bit B_X(0), and an output to provide both carry generate value g_x(0) and carry propagate value p_x(0). The remainder of the carry lookahead operation modules 410 of stage 401 comprise a NAND gate 413 having inputs to receive the corresponding bits A(n) and B_X(n) and an output to provide the resulting carry generate value g_x(n), as well as a NOR gate 414 having inputs to receive the corresponding bits A(n) and B_X(n) and an output to provide the resulting carry propagate value p_x(n).

Each carry lookahead operation module 416 of the second stage 402 receives the two carry generate values and two carry propagate values generated by two corresponding carry lookahead operation modules of the first stage 401 and two outputs to provide a carry generate value (denoted ag(N), where N=3, 5, 7, . . . , 33) and a carry propagate value (denoted ap(N), where N=3, 5, 7, . . . , 33). Each carry lookahead operation module 416 includes an OR gate 418, a NAND gate 420 and a NOR gate 422. The OR gate 418 has inputs to receive values g_x(n−1) and p_x(n) and an output connected to an input of the NAND gate 420. The NAND gate 420 includes another input to receive the value g_x(n) and an output to provide the carry generate value ag(n). The NOR gate 422 includes inputs to receive the values p_x(n) and p_x(n−1) and an output to provide the carry propagate value ap(n).

Each carry lookahead operation module 424 of the third stage 403 receives the two carry generate values and two carry propagate values generated by two corresponding carry lookahead operation modules of the second stage 402 and two outputs to provide a carry generate value (denoted bg_x(N)) and a carry propagate value (denoted bp_x(N)). Each carry lookahead operation module 424 includes an AND gate 426, a NOR gate 428 and a NAND gate 430. The AND gate 426 has inputs to receive values ag(n−1) and ap(n) and an output connected to an input of the NOR gate 428. The NOR gate 428 includes another input to receive the value ag(n) and an output to provide the carry generate value bg_x(n). The NAND gate 430 includes inputs to receive the values ap(n) and ap(n−1) and an output to provide the carry propagate value bp_x(n).

Each carry lookahead operation module 432 of the fourth stage 404 receives the two carry generate values and two carry propagate values generated by two corresponding carry lookahead operation modules of the third stage 403 and two outputs to provide a carry generate value (denoted cg(N)) and a carry propagate value (denoted cp(N)). The logic of the carry lookahead operation module 432 is similar to the logic of the carry lookahead operation module 416 of the second stage 402. Accordingly, each carry lookahead operation module 432 includes an OR gate 434, a NAND gate 436 and a NOR gate 438. The OR gate 434 has inputs to receive values bg_x(n−1) and bp_x(n) and an output connected to an input of the NAND gate 436. The NAND gate 436 includes another input to receive the value bg_x(n) and an output to provide the carry generate value cg(n). The NOR gate 438 includes inputs to receive the values bp_x(n) and bp_x(n−1) and an output to provide the carry propagate value cp(n).

Each carry lookahead operation module 440 of the fifth stage 405 receives the two carry generate values and two carry propagate values generated by two corresponding carry lookahead operation modules of the fourth stage 404 and two outputs to provide a carry generate value (denoted dg_x(N)) and a carry propagate value (denoted dp_x(N)). The logic of the carry lookahead operation module 440 is similar to the logic of the carry lookahead operation module 424 of the third stage 403. Accordingly, each carry lookahead operation module 440 includes an AND gate 442, a NOR gate 444 and a NAND gate 446. The AND gate 442 has inputs to receive values cg(n−1) and cp(n) and an output connected to an input of the NOR gate 444. The NOR gate 444 includes another input to receive the value cg(n) and an output to provide the carry generate value dg_x(n). The NAND gate 446 includes inputs to receive the values cp(n) and cp(n−1) and an output to provide the carry propagate value dp_x(n).

Referring now to FIG. 5, an exemplary conventional logic implementation of the inequality logic 304 (FIG. 3) based on the carry generate values and carry propagate values generated by the carry lookahead adder 400 (FIG. 4) is illustrated in accordance with at least one embodiment of the present disclosure. Although the illustrated conventional logic implementation is described for a thirty-four (34) bit comparison, it will be appreciated that the illustrated implementation can be scaled based on the number of bits for the operands being compared without departing from the scope of the present disclosure.

In the depicted example, the inequality logic 304 includes OR gates 501, 506 and 510, NAND gates 502, 507 and 511, NOR gates 504, 509 and 513, and an inverter 515. The OR gate 501 includes inputs to receive the values g_x(0) and p_x(1) and an output connected to the input of the NAND gate 502. The NAND gate 502 includes another input to receive the value g_x(1) and an output coupled to an input of the AND gate 503. The AND gate 503 includes another input to receive the value ap(3) and an output connected to an input of the NOR gate 504. The NOR gate 504 includes another input to receive the valve ag(3) and output connected to an input of the OR fate 506. The OR gate 506 includes another input to receive the value bp_x(7) and an output connected to an input of the NAND gate 507. The NAND gate 507 includes another input to receive the value bg_x(7) and an output connected to an input of the AND gate 508. The AND gate 508 includes another input to receive the value cp(15) and an output connected to an input of the NOR gate 509. The NOR gate 509 includes another input to receive the value cg(15) and an output connected to an input of the OR gate 510. The OR gate 510 includes another input to receive the value dp_x(31) and an output connected to an input of the NAND gate 510. The NAND gate 510 includes another input to receive the value dg_x(31) and an output connected to the AND gate 512. The AND gate 512 includes another input to receive the value ap(33) and an output connected to an input of the NOR gate 513. The NOR gate 513 includes another input to receive the value ag(33) and an output to provide an inequality relationship indicator 514 (AₗₜB_{33:0}) indicating whether the value of the operation portion A[33:0] is less than the value of the operand portion B[33:0]. The inverter 515 includes an input connected to the output of the NOR gate 513 and an output to provide an inequality relationship indicator 516 (A_{ge}B_{33:0}) indicating whether the value of the operation portion A[33:0] is at least as great as the value of the operand portion B[33:0].

Referring now to FIG. 6, an exemplary logic implementation of the equality logic 306 (FIG. 3) based on the carry generate values and carry propagate values generated by the carry lookahead adder 400 (FIG. 4) is illustrated in accordance with at least one embodiment of the present disclosure. Although the illustrated logic implementation is described for a thirty-four (34) bit comparison, it will be appreciated that the illustrated implementation can be scaled based on the number of bits for the operands being compared without departing from the scope of the present disclosure.

As illustrated by Table 1 below, it has been observed that when a carry lookahead operation is performed on a bit from operand A and the inverted bit from operand B based on EQs. 1 and 2 for the propagation (Pᵢ) and generation (Gᵢ) of a carry, the bits are equal (Eᵢ) only when a carry is propagated (i.e., the carry generate value is logic 1) and a carry is not generated (i.e., the carry propagate value is logic 0). The truth table of Table 1 is represented in equation form by Equation 3.

TABLE 1
Truth Table

| Pᵢ | Gᵢ | Eᵢ |
|---|---|---|
| 0 | 0 | 0 |
| 0 | 1 | 0 |
| 1 | 0 | 1 |
| 1 | 1 | 0 |

Pᵢ=(Aᵢ+Bᵢ)*(Aⱼ+Bⱼ), where i>j EQ. 1

Gᵢ=[(Aᵢ+Bᵢ)*(Aⱼ*Bⱼ)]+(Aᵢ*Bᵢ), where i>j EQ. 2

E=P* G̅ EQ. 3

From the above equations, it will be appreciated that when all of the carry propagate values generated by the carry lookahead adder 400 have a logic 1 value and all of the carry generate values generated by the carry lookahead adder 400 have a logic 0 value, the compared portions of the operands A and B can be said to be equal (i.e., have an equality relationship of “equal”). Conversely, if any of the carry propagate values have a logic 0 value or any of the carry generate values have a logic 1 value, the compared portions of the operands A and B can be said to be not equal (i.e., have an equality relationship of “not equal”). The logic of FIG. 6 illustrates a particular implementation to determine the condition indicated by Equations 1-3 for the carry lookahead adder 400.

In the depicted example, the equality logic 306 includes NAND gates 601, 603, 607, 611, 617, 619 and 621, OR gates 602, 606 and 610, NOR gates 605, 609, 614, 616, 618 and 623, and inverters 613, 616 and 620. The NAND gate 601 includes inputs to receive values A(0) and B_X(0) and an output connected to an input of the OR gate 602. The OR gate 602 includes another input to receive the value p_x(1) and an output connected to an input of the NAND gate 603. The NAND gate 603 includes another input to receive the value g_x(1) and an output connected to an input of the AND gate 604. The AND gate 604 includes another input to receive the value ap(3) and an output connected to an input of the NOR gate 605. The NOR gate 605 includes another input to receive the value ag(3) and an output connected to an input of the OR gate 606. The OR gate 606 includes another input to receive the value bp_x(7) and an output connected to an input of the NAND gate 607. The NAND gate 607 includes another input to receive the value bg_x(7) and an output connected to an input of the AND gate 608. The AND gate 608 includes another input to receive the value cp(15) and an output connected to an input of the NOR gate 609. The NOR gate 609 includes another input to receive the value cg(15) and an output connected to an input of the OR gate 610. The OR gate 610 further includes an input to receive the value dp_x(31) and an output connected to an input of the NAND gate 611. The NAND gate 611 further includes an input to receive the value dg_x(31) and an output connected to the input of the inverter 612. It will be appreciated that the output of the inverter 612 represents the value G̅_{31:0}. The output of the inverter 612 is connected to an input of the NAND gate 619.

The input of the inverter 613 receives the value cp(15) and the output of the inverter 613 is connected to an input of the NOR gate 614. The NOR gate 614 further includes an input to receive the value dp_x(31) and an output connected to an input of the NAND gate 619. The NOR gate 616 includes inputs to receive the values p_x(0) and p_x(1) and an output connected to an input of the NAND gate 617. The NAND gate 617 further includes an input to receive the value bp_x(7) and an output connected to an input of the NAND gate 619. The output of the NAND gate 619 is connected to an input of the NOR gate 623. It will be appreciated that the output of the NAND gate 619 represents the value (P_{31:0}* G̅_{31:0}).

The input of the inverter 620 is to receive the value ag(33) and the output of the inverter 620 is connected to an input of the NAND gate 621. The NAND gate 621 also includes an input to receive the value ap(33) and an output connected to the NOR gate 623. It will be appreciated that the output of the NAND gate 619 represents the value (P_{31:0}* G̅_{31:0}) and that the output of the NAND gate 621 represents the value (P_{33:32}* G̅_{33:32}). Accordingly, the output of the NOR gate 623 represents the value P_{33:0}* G̅_{33:0}, which, as noted above with respect to Equation 3, indicates the equality relationship (E_{33:0}) between the operand portions A[33:0] and B[33:0].

Other embodiments, uses, and advantages of the disclosure will be apparent to those skilled in the art from consideration of the specification and practice of the disclosure disclosed herein. The specification and drawings should be considered exemplary only, and the scope of the disclosure is accordingly intended to be limited only by the following claims and equivalents thereof.

What is claimed is:

1. A method comprising:
determining a first carry propagate value and a second carry generate value based on a first carry lookahead operation for a first operand and a second operand;
determining a second carry propagate value and a second carry generate value based on a second carry lookahead operation for the first operand and the second operand;
determining an equality relationship between the first operand and the second operand based on at least two of the first carry propagate value, the second carry propagate value, the first carry generate value and the second carry generate value; and
determining a first inequality relationship between the first operand and the second operand based on at least two of the first carry propagate value, the second carry propagate value, the first carry generate value and the second carry generate value.

2. The method of claim 1, further comprising:
determining a second inequality relationship between the first operand and the second operand.

3. The method of claim 1, further comprising:
determining a sum of the first operand and the second operand based on the first carry propagate value, the second carry propagate value, the first carry generate value and the second carry generate value.

4. The method of claim 3, wherein determining the equality relationship, determining the first inequality relationship, and determining the sum occur substantially in parallel.

5. The method of claim 1, wherein determining the equality relationship and determining the first inequality relationship occur substantially in parallel.

6. The method of claim 1, wherein determining the first carry propagate value and the first carry generate value occurs substantially in parallel with determining the second carry propagate value and the second carry generate value.

7. The method of claim 1, further comprising:
determining a third carry propagate value and a third carry generate value based on a third carry lookahead operation for the first carry propagate value, the second carry propagate value, the first carry generate value and the second carry generate value;
wherein determining the equality relationship between the first operand and the second operand comprises determining the equality relationship based on at least one of the second propagate value and the second carry generate value; and
wherein determining the inequality relationship between the first operand and the second operand comprises determining the inequality relationship based on at least one of the second propagate value and the second carry generate value.

8. A device comprising:
a carry lookahead adder comprising a first input to receive a first operand, a second input to receive a second operand, a plurality of carry lookahead stages, a first plurality of outputs and a second plurality of outputs, each of the first plurality of outputs to provide a corresponding carry propagate value of a corresponding carry lookahead stage of the plurality of hierarchical carry lookahead stages and each of the second plurality of outputs to provide a corresponding carry generate value of a corresponding carry lookahead stage of the plurality of carry lookahead stages; and
logic having a first plurality of inputs, each coupled to a corresponding one of the first plurality of outputs, a second plurality of inputs, each coupled to a corresponding one of the second plurality of outputs, and an output to provide an equality relationship indicator based on at least a first subset of the carry propagate values and at least a first subset of the carry generate values of the carry lookahead adder.

9. The device of claim 8, wherein each carry lookahead stage of a subset of the plurality of carry lookahead stages generates a corresponding plurality of carry propagate values and a corresponding plurality of carry generate values based on a carry propagate value and a carry generate value generated at a prior carry lookahead stage of the plurality of carry lookahead stages.

10. The device of claim 9, wherein a first carry lookahead stage of the plurality of carry lookahead stages generates a plurality of carry propagate values and a plurality of carry generate values based on bit values of the first operand and the second operand.

11. The device of claim 8, wherein the logic is to determine, for each carry lookahead stage of the plurality of carry lookahead stages, whether each carry propagate value at the carry lookahead stage has a first value and each carry generate value at the carry lookahead stage has a second value.

12. The device of claim 11, wherein:
the logic provides a third value for the equality relationship indicator in response to determining that each carry propagate value at each carry lookahead stage of the plurality of carry lookahead stages has the first value and determining that each carry generate value at each carry lookahead stage of the plurality of carry lookahead stages has the second value; and
wherein the third value for the equality relationship indicator indicates that the first operand is equal to the second operand.

13. The device of claim 12, wherein:
the logic provides a fourth value for the equality relationship indicator in response to determining that any carry propagate value at any carry lookahead stage of the plurality of carry lookahead stages has the second value or determining that any carry generate value at any carry lookahead stage of the plurality of carry lookahead stages has the second value; and
wherein the fourth value for the equality relationship indicator indicates that the first operand is not equal to the second operand.

14. The device of claim 8, wherein the logic further comprises a second output to provide a first inequality relationship indicator based on at least a second subset of the carry propagate values and at least a second subset of the carry propagate values of the carry lookahead adder.

15. The device of claim 14, wherein the logic further comprises a third output to provide a second inequality relationship indicator based on the equality relationship indicator and the first inequality relationship indicator.

16. A processing device comprising:
logic to determine a first carry propagate value and a second carry generate value based on a first carry lookahead operation for a first operand and a second operand;
logic to determine a second carry propagate value and a second carry generate value based on a second carry lookahead operation for the first operand and the second operand;
logic to determine an equality relationship between the first operand and the second operand based on at least two of the first carry propagate value, the second carry propagate value, the first carry generate value and the second carry generate value; and
logic to determine a first inequality relationship between the first operand and the second operand based on at least two of the first carry propagate value, the second carry propagate value, the first carry generate value and the second carry generate value.

17. The processing device of claim 16, further comprising:
logic to determine a second inequality relationship between the first operand and the second operand.

18. The processing device of claim 16, further comprising:
logic to determine a sum of the first operand and the second operand based on the first carry propagate value, the second carry propagate value, the first carry generate value and the second carry generate value.

19. The processing device of claim 16, wherein the logic to determine the equality relationship and the logic to determine the first inequality relationship are configured to operate substantially in parallel.

20. The processing device of claim 16, further comprising:
logic to determine a third carry propagate value and a third carry generate value based on a third carry lookahead operation for the first carry propagate value, the second carry propagate value, the first carry generate value and the second carry generate value;
wherein the logic to determine the equality relationship between the first operand and the second operand comprises logic to determine the equality relationship based on at least one of the second propagate value and the second carry generate value; and
wherein the logic to determine the inequality relationship between the first operand and the second operand comprises logic to determine the inequality relationship based on at least one of the second propagate value and the second carry generate value.
